(19) United States
(12) Patent Application Publication
(10) Pub. No.: US 2013/0300937 A1
(43) Pub. Date: Nov. 14, 2013

(54) APPARATUS AND METHOD OF VIDEO COMPARISON

(71) Applicant: SONY CORPORATION, Tokyo (JP)

(72) Inventors: Michael WILLIAMS, Winchester (GB); Mark Grinyer, Southampton (GB)

(73) Assignee: Sony Corporation, Tokyo (JP)

(21) Appl. No.: 13/782,145

(22) Filed: Mar. 1, 2013

(30) Foreign Application Priority Data
May 14, 2012 (GB) 1208401.8

(51) Int. Cl. H04N 5/265; H04N 5/262

(52) U.S. Cl. CPC H04N 5/265; H04N 5/2628
USPC 348/581; 348/584

(57) ABSTRACT

A video comparison apparatus for sports coverage comprises a video input arranged in operation to receive video frames of captured video footage from a video camera having a fixed viewpoint of a scene, the video frames being associated with respective times referenced to a universal clock, a control input arranged in operation to receive event data indicating that an event has occurred, the event being associated with a time referenced to the universal clock, a video processor, and a video compositor; and the video processor is operable to select two or more instances of video footage associated with universal times responsive to the universal times of two or more instances of the event, and the video compositor is operable to superpose onto successive video frames of one instance of selected video footage at least a first part of a corresponding video frame from each of the one or more other selected instances of video footage.

### BACKGROUND

1. Field of the Disclosure

The present disclosure relates to an apparatus and method of video comparison.

2. Description of the Related Art

Conventional sports coverage frequently comprises a combination of fixed and mobile camera viewpoints, and a director selects from among these viewpoints to illustrate the most salient or exciting progression of the sport for broadcast.

Occasionally, a director may wish to compare the performance of one or more participants in the sports event as they repeatedly perform a task, such as taking a bend or passing a lap marker in a race, or taking a penalty in football.

This necessitates accurate cueing of the relevant video streams (and/or parts of the same video stream) in order to show the comparative footage, for example as a split-screen.

However, it would be preferable to improve the ease and flexibility with which such comparisons were managed, at least for certain sports.

### SUMMARY

A video comparison apparatus for sports coverage, comprising a video input arranged in operation to receive video frames of captured video footage from a video camera having a fixed viewpoint of a scene, the video frames being associated with respective times referenced to a universal clock and a control input circuitry is arranged in operation to receive event data indicating that an event has occurred, the event being associated with a time referenced to the universal clock. The apparatus also comprises a video processor and a video compositor where the video processor circuitry is configurable to select two or more instances of video footage associated with universal times responsive to the universal times of two or more instances of the event and the video compositor circuitry is configurable to superpose onto successive video frames of one instance of selected video footage at least a first part of a corresponding video frame from each of the one or more other selected instances of video footage.

### BRIEF DESCRIPTION OF DRAWINGS

Embodiments of the present disclosure will now be described by way of example with reference to the accompanying drawings, in which:

FIG. 1 is a schematic diagram of a racing track, video cameras and sensors, in accordance with an embodiment of the present disclosure.

FIG. 2 is a schematic diagram of a video system, in accordance with an embodiment of the present disclosure.

FIG. 3A is a schematic diagram of a video camera and effective placements of a virtual video camera.

FIG. 3B is a schematic diagram of a video camera and effective placements of a virtual video camera.

FIG. 4 is a schematic diagram of a general purpose computer, operable as a pre-processor, a cueing unit and/or a video comparator, in accordance with an embodiment of the present disclosure.

FIG. 5 is a flow diagram of a method of video comparison, in accordance with an embodiment of the present disclosure.

FIG. 6 is a schematic diagram of a a projection onto a virtual image plane, in accordance with an embodiment of the present disclosure.

### DETAILED DESCRIPTION OF EMBODIMENTS

An apparatus and method of video comparison are disclosed. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

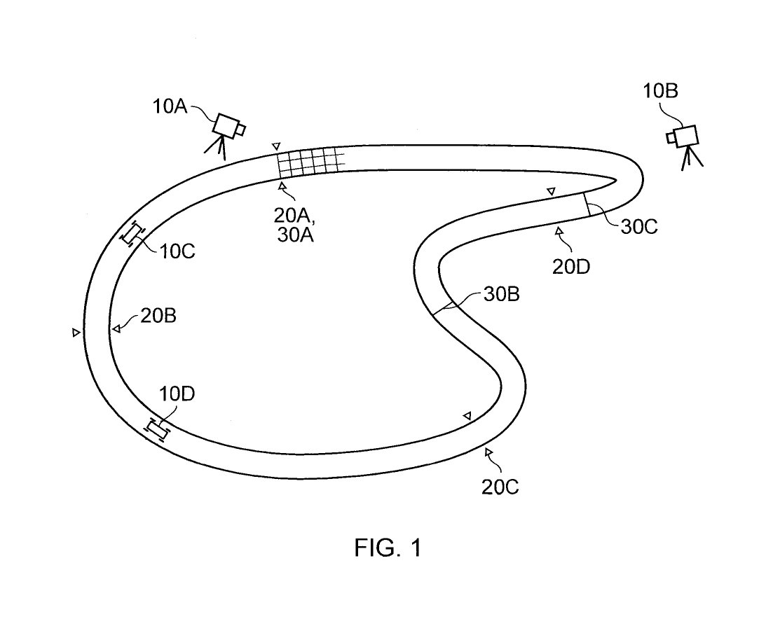

Referring now to FIG. 1, in an embodiment of the present disclosure a plurality of camera viewpoints (10A-D) are provided for a Formula One race, or more generally any race or sport following a predetermined path, such as a horse race, a cycle race in a velodrome, a ski slalom or the like. Optionally the path may be discretely defined, for example by a series of waypoints such as buoys in a yacht race.

The camera viewpoints may be a combination of fixed points, for example trackside at the starting grid (10A) or at important corners of a track (10B), and also mobile points, for example on some or all of the cars (10C,D) (or for other races, on the jockey, skier, bicycle, yacht etc.).

In an embodiment of the present disclosure, one or more Formula One cars are equipped with one or more video cameras, and wireless streams from these cameras include a respective ID that can be associated with the particular car and/or driver, enabling the camera and hence viewpoint of a particular driver's vehicle to be readily selected by a director.

Separately, the cars and optionally the race track comprise a plurality of sensors.

The sensors for the race track may include timing units at predetermined positions (20A-D) that provide accurate timing of the racing cars at these predetermined positions, and hence information about the race order and the time separation between cars. These timing units may be placed on, under or by the track to detect one or more of near-field transponders, radio transponders, infra-red transponders, optical patterns (such as barcode or QR code patterns), or any other suitable remote identification means positioned on a racing car to identify it at the moment it reaches that predetermined position.

This timing data is measured in (or subsequently referenced to) a universal clock signal generated by a universal clock (not shown).

Similarly, the racing car itself collects telemetry data such as one or more of GPS position data, axle speed data and steering data.

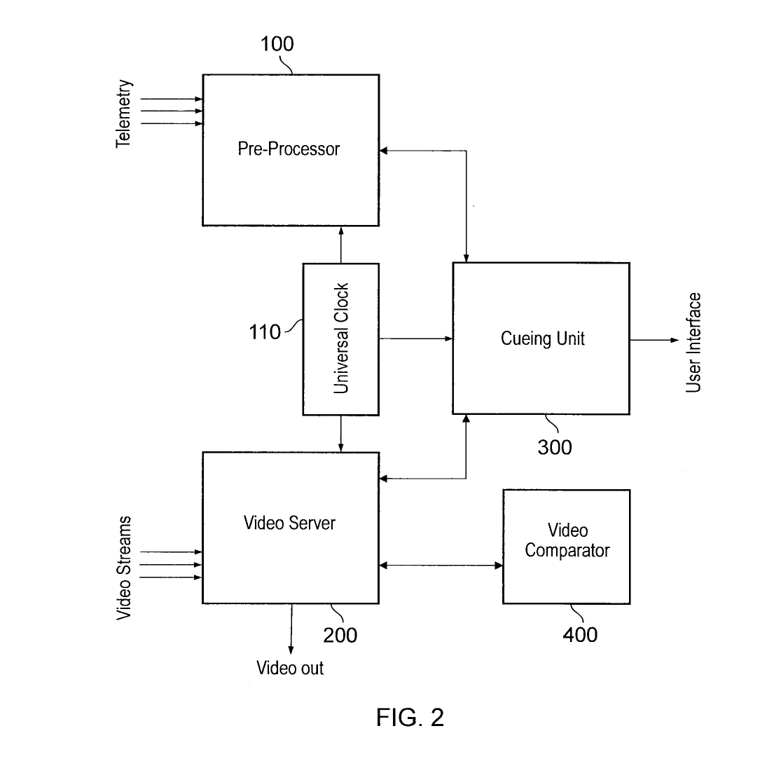

Referring now also to FIG. 2, this in-car telemetry, and if present the track-side position and timing telemetry, are transmitted to an information pre-processor 100.

The information pre-processor 100 comprises a model of the race track. This model may be an accurate and detailed geometry of the race track, or a simple line and curve representation of the track, or it may simply model the track's mean length, using real or arbitrary units. More generally, the pre-processor model is operable to represent a location on the race track as a function of distance from a predetermined reference point (such as a starting line). The distance may be expressed in real units (such as meters) or arbitrary units (such as a percentage of the mean track length).

The information pre-processor then estimates from the received telemetry the current location of a racing car on the race track. To a first approximation, the current location of the racing car is thus the distance from the predetermined reference point along the track at the current time.

The current time is defined by the current (most recently issued) universal clock signal from the universal clock 110.

In the event that a telemetry source is able to receive the universal clock signal (for example, the track-side timing unit may receive the universal clock signal), then the telemetry data received by the pre-processor may have a universal time stamp already associated with it. Alternatively or in addition, the pre-processor may associate the telemetry data with a universal time signal upon its receipt. Optionally it may apply a time offset if there are known delays in receiving or extracting such telemetry data.

The result is that telemetry data received by the pre-processor 100 is associated with respective times from the universal clock that specify when that telemetry data was current.

It will be appreciated that the above described telemetry data may be received at different times and with different frequencies. Thus for example the accurate track-side timing and position data may occur at only 4 or 5 irregularly spaced intervals (20A-D). Meanwhile GPS data may be received more regularly, for example every second. Finally, information such as axel speed may be received every 1/10^{th} of a second. It will be appreciated that these values are exemplary only and are non-limiting.

Hence for example, if accurate position and time data is received from a trackside sensor at a universal time of 1.000 seconds, and a GPS signal is received from the car at 1.010 seconds, and axle speed data is received at both 1.005 and 1.015 seconds, then it is possible to estimate the position of the car along the track at each thousandth of a second between 1.000 and 1.010 seconds based upon the known position at 1.000 seconds and the extrapolated/interpolated axle speed of the car between 1.000 and 1.010 seconds, and optionally also to validate and possibly correct the GPS position received at 1.010 seconds.

Moreover, if for example the current time is 1.018 seconds, it is possible to use a combination of the trackside data, GPS data and extrapolated axle speed data (and hence elapsed distance) to estimate the location of the racing car along the track at this time. Again it will be appreciated that the timing values used above are exemplary only and non-limiting.

This estimated location is then stored as data in association with the corresponding time from the universal clock (for example 1.018 seconds), typically also in association with an ID of the respective racing car and optionally a lap counter.

Hence over the course of the race, it is possible to estimate and store the location of the racing car along the track for any selected time.

More generally therefore, the pre-processor 100 is operable to analyse telemetry data from a car (and where available, from the track side), in order to estimate the current location of the car along the track, as referenced to the universal clock. By storing this information, the position of the car at each moment in the race can be subsequently accessed.

In an embodiment of the present disclosure, a video server 200 (or alternatively the pre-processor 100) is operable to associate the current universal time signal with a current video frame as it is received from each camera. These time-stamped video frames are archived to the video server 200, and frames from one of more video streams may also be mirrored to form a live feed at the director's discretion. It will be appreciated that optionally not every video frame in a respective video stream may be time stamped if it is still possible to reliably estimate the universal time for unstamped video frames by interpolation or frame counting. For example, only the frame at the start of a group of frames (or some other frame sequence structure) may be time stamped.

Other metadata may be associated as desired with the video frames, or a group of frames, or a video stream. These may include but are not limited to the driver name, the car number, the racing team, and/or the lap number.

Moreover, in an embodiment of the present disclosure, for the car-mounted cameras it is also possible to associate a respective frame of the video stream with the corresponding location of the car along the track (or vice-versa), based upon the common reference of the universal clock. Thus the location data whose car ID and universal time matches the video frame with the same car ID and universal time can be associated together.

It will be appreciated that where video frames are recorded at 25, 50, 60 or some other number of frames per second, this may represent a sub-sampling of the available universal time signals. Hence in an embodiment of the present disclosure, for a particular car the location data is only estimated for those time signals that are associated with a video frame from that car. In this case, if the video server applies the time stamps then it can communicate the relevant times to the pre-processor.

Meanwhile, for fixed position cameras it is possible to associate with a particular video frame the car or driver ID for a car that is at a predetermined location relative to the camera for that frame—for example exactly at the same location (within a predetermined margin) for a camera located at the finish line, or 200 meters short of the camera for a camera covering a sharp corner.

However if it is not desirable to store such location data in association with the video frames directly (for example if the video format does not accommodate sufficiently large metadata fields, or to preserve video server capacity, or maintain compatibility with other devices) then the location data may be separately stored (for example in the pre-processor 100 or a cueing unit 300), associated with the universal time code and/or frame number, and the stream ID of the relevant video frame.

Alternatively, the location data may not be explicitly associated with the video frames, either by the video server 200, the pre-processor 100 or the cueing unit 300. In this case, the video frame corresponding to a location on the race track may be accessed as required, again by virtue of their common reference to the universal clock signals.

Consequently, in an embodiment of the present disclosure, it is possible to select a video frame corresponding to the particular location of a particular car on the track for a particular lap, by selecting the appropriate video stream and the appropriate location and lap, obtaining the universal time stamp associated with the location and lap and using this to obtain the relevant video frame in the selected video stream that has the corresponding time stamp.

In an embodiment of the present disclosure, the cueing unit 300 is operable to perform such a selection. When a lap, location and camera are selected, the cueing unit accesses the associated time stamp (recorded either in the cueing unit, pre-processor or video server as described previously) and then accesses the corresponding video frame in the selected camera stream from the video server.

In an embodiment of the present disclosure, where the video frames have been encoded (for example using MPEG 2 or a similar scheme employing inter-frame prediction) then if the relevant frame is a so-called P or B frame or equivalent, then the cueing unit is operable to access the preceding or following frames required to reconstruct the selected video frame and commence playback from that frame.

Referring now again to FIG. 1, in an embodiment of the present disclosure the pre-processor or alternatively the cueing unit may be pre-set with event locations 30A-C. These locations may be defined simply as distances along the track from the reference position, which happen to correspond with positions of interest on the physical track (such as the start/finish line 30A, or difficult bends 30B, C). If the pre-processor comprises a more complex geometric model, then the event locations may be defined with respect to the positions of interest on such a model, as long as these can be correlated with the location data estimated from the telemetry as described previously.

In an embodiment of the present disclosure, the pre-processor or the cueing unit is operable to log the universal time and the driver or car ID for a car when the location data indicates that it has reached an event location. It will be appreciated that if the event location coincides with a track side sensor (such as the starting line 20A, 30A) then the event location will typically be very precisely defined. Meanwhile for other event locations 30B, 30C, the physical accuracy may not be so precise. Nevertheless, to within an accuracy of a few meters or less (depending in part on vehicle speed, wheel slippage and the like), the universal time at which a car reached an event location can be logged for each lap of the race.

Consequently, for respective video streams (and hence respective cars/drivers) the cueing unit can cue the video frames for these event locations by reference to the associated universal time stamp.

To facilitate this, the cueing unit may present a selectable array of cue-points via a graphical user interface. Hence for example a director may select an event location via the interface, and then select to display one driver's video at that location for a subset of prior laps, or select to display a subset of drivers' videos at that location for one lap. Alternatively the director may cue their own set of videos, for example to provide coverage of a notable incident taken from several drivers' viewpoints over several laps.

As a result, using such an interface a director can quickly select, for example, the in-car camera view for a particular driver at an event location 30C (a tight bend) for laps 10, 20, 30 and 40, and broadcast these as a 4-way split screen to provide a side-by-side comparison of the driver's performance at the same event location over the course of the race. More generally, the director may also be able to select video from pre-race laps or any archived lap in a similar manner, such as for example the lap with the driver's fastest practice time, or the fastest ever lap time on that course.

Likewise, the director can quickly select for example the in-car camera view for that bend for the current lap for those camera-equipped cars that have passed the bend, to compare driving styles or vehicle performance for different racers at the same point in the race.

The cueing unit may also be able to suggest or trigger cues in response to events. Hence for example, the director can set the cueing unit to trigger footage of the last three drivers that tackled the bend to appear when the currently viewed (live view) driver reaches the event location, enabling exact comparisons to be synchronised with a live feed.

In a similar vein, the pre-processor and/or the cueing unit may log the universal time codes for notable changes in telemetry or other in-car data for a particular car. For example, a sudden change in speed or steering may indicate a crash or near-miss, whilst a loss of tire temperature data may indicate a puncture.

Hence the pre-processor may comprise a telemetry analyser arranged in operation to detect changes in telemetry that exceed respective predetermined thresholds, and which in response to such detected changes, is operable to log the universal clock signal (and if not already done, also the car ID) at the time of the change. The logged universal clock time and car ID can then be used to access the relevant frame in the video stream.

The cueing unit may then present to the director the opportunity to cue video from the car, for example from 3 seconds prior to the event. In addition, optionally the cueing unit may evaluate whether another camera-equipped car was within a predetermined distance behind the first car, and offer to also or alternatively cue video from the trailing car from the same moment.

As noted previously, the location of the car at a particular time may be approximate to within a few meters. Consequently, when cueing multiple video streams, the cueing unit may select the cued frame from one stream (for example that of the most recent lap, or the first driver), and optionally for each of the other streams to be displayed, compare neighbouring frames to their default cue points in order to detect whether one of these frames more closely matches the appearance of the selected frame, and consequently may use a better matching frame as the initial cue point instead, in order to reduce any spatial disparity in the separate feeds.

As noted previously, more generally the director can also cue the view from any camera equipped car, for any lap, at any position along the track. Again this can quickly be achieved by selecting the driver and the lap, and then for example selecting a position on a graphical representation of the race track in order to cue the corresponding video from the server.

It will be appreciated that the pre-processor and the cueing unit may be separate or may be integrated into a single unit. It will also be appreciated that the wireless reception and extraction of video data and/or telemetry data may be performed by a separate device to which the pre-processor is operably coupled. It will be further appreciated that the video server may be separate or may be integrated with the pre-processor and/or the cueing unit.

Hence in summary, in an embodiment of the present disclosure a director is able to cue up multiple video streams based upon a geographic location (e.g. a particular bend on a race track), in order to provide comparative views of the race at that location either as a function of time for one racer, or for a plurality of racers, or a combination of both.

Notably, some or all of the functionality of the cueing unit may be implemented remotely, for example via the internet. In this embodiment, whilst the director may have a studio based or track-side version of the cueing unit that is used to control a primary broadcast signal, individual client subscribers may implement features of the cueing unit on their own general purpose computer (such as a PC, iPhone® or a suitable domestic IPTV set-top box) that enable them to select for example, one or more drivers, a lap (or by default the current lap) and a position on the race track (or one or several preselected position), and then receive footage of the or each viewpoint in a similar manner to the director. In this case the footage may be supplied by a web server that mirrors the video streams from the video server at a resolution suitable for IPTV or similar webcasting techniques.

Hence more generally a subscribing end user may have access to some or all of the cueing functions described herein via a (preferably encrypted) internet connection.

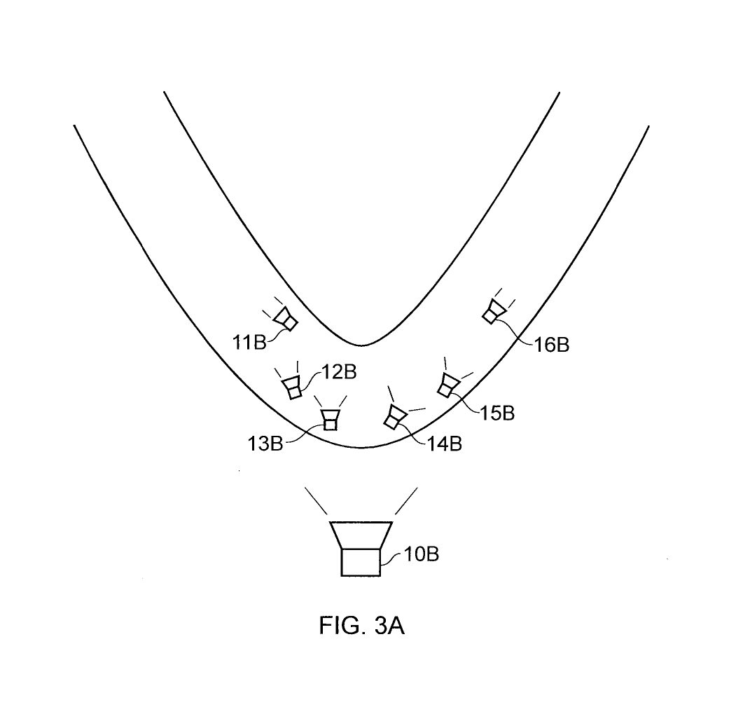

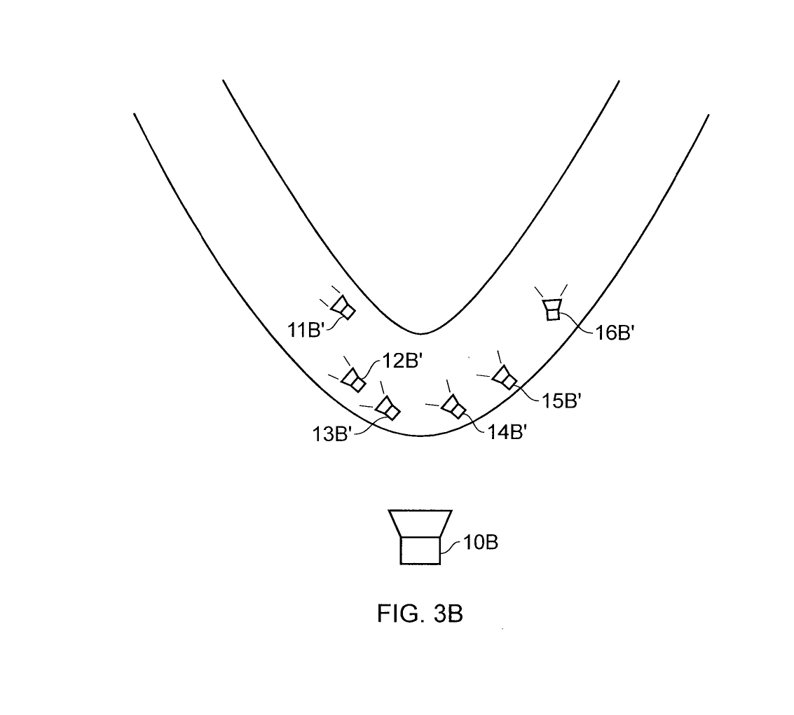

Referring now to FIG. 1 and also FIG. 3A, in an embodiment of the present disclosure one or more of the fixed location cameras is a high resolution camera (or a set of cameras arranged to generate together a composite or ‘stitched’ high resolution image), such as for example a 3840×2160 pixel image, or a 7680×4320 pixel image. In FIG. 3, camera 10B of FIG. 1 is illustrated as such a high resolution camera viewing its respective bend of the race track. As such it will be understood that herein ‘high resolution’ is typically 2 or more times the resolution of high definition (HD) video, which operates at 1920×1080 pixels. Hence it will be appreciated that such high resolution images can be subsampled or otherwise re-sized to provide conventional HD resolution images. Moreover, a conventional HD image can be extracted as a region of the stitched high resolution image at the high resolution image's native resolution. Between these extremes, different sized regions of the stitched high resolution image can be extracted as conventional HD images by applying appropriate resampling ratios to the high resolution image.

Consequently, it is possible to pan and zoom within the stitched high resolution image at conventional HD (or for that matter SD) resolutions.

However, in an embodiment of the present disclosure, it is possible to provide a superior and more realistic rotational pan, tilt and/or zoom.

Preferably, the high resolution camera is locked-off so that its view remains static. The camera (or the cameras combining to form the high resolution camera) may have fish-eye, ultra wide angle or wide angle lenses as appropriate in order to capture a wide view, for example so as to capture the approach to a bend, the bend itself and the exit from the bend (or for example to capture the full width of a football pitch).

Optionally, the video comparator 400 is then operable to substantially correct distortions in the image from the high definition camera, such as any known lens distortion for the current zoom and focal settings, and similarly any curvilinear distortion from a fish-eye, ultra-wide angle or wide angle lens may be substantially rectified.

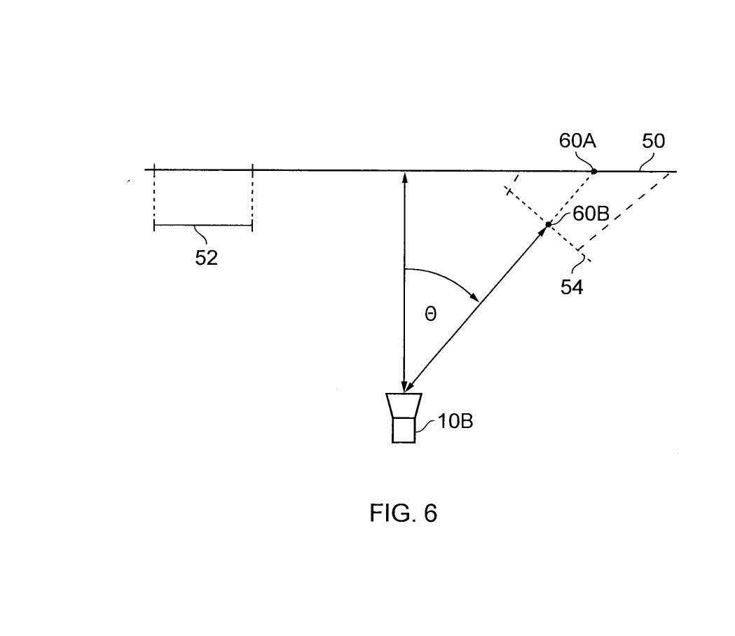

Referring then to FIG. 6, the high resolution image 50 is captured in a first image plane perpendicular to the camera 10B (i.e. along the camera's optical axis). As a result, objects within the image that are not on the optical axis will be seen within the image at a different angle. As a result, when panning and zooming in the manner described above, the resulting image can look unnatural because the viewer expects to see an image with a viewpoint consistent with having an optical axis at the centre of the image. However, as shown in FIG. 6, a conventional selection of a region of the high resolution image 52 will not look natural as the optical centre of the image is not present.

In order to improve on this, in an embodiment of the present disclosure for a virtual panning angle theta, a virtual image plane 54 is created, and the pixels 60A from the high resolution image are back-projected to the camera position through to the virtual image plane to form re-positioned pixels 60B.

The resulting image 54 has a more natural look to it than the straightforward selection of a region within the high resolution image, and resembles the output of an actual pan or tilt by a freely pivotable camera system if it occupied the same location as camera 10B.

Hence more generally, a video comparator 400 is operable to generate the view from a virtual camera positioned with an angle of rotation (horizontally and/or vertically) offset from the optical axis of the real camera, thereby generating a more natural pan or tilt. In addition, the image may be zoomed by the same transform, a the position (radius) of the virtual image plane along the axis for the virtual panning angle can be used to determine the level of zoom. Hence any zoom can be achieved by the same transformation mapping as the pan and/or tilt.

In addition to virtual rotation of the camera at the same position as the high resolution camera 10B, in principle it is possible to generate limited virtual movement away from the position of the high resolution virtual camera.

Hence in an embodiment of the present disclosure, the video comparator 400 comprises an accurate model of the geometry of the race track, at least for that part of the track viewed by the high resolution camera (for another sport such as football, the geometry would be of a football pitch, for example). It will be appreciated that this geometry model can be the same as that held by the pre-processor, if as described previously it holds such an accurate model, and optionally the pre-processor 100 is operable as the video comparator 400.

The video comparator 400 is then operable to match features of the captured image to the geometric model of the race track. For example, features such as chevrons, track edging and stadium structures may be used to identify where pixels of the high definition image project onto the geometric model. Hence the features of the scene may be treated as a (large) augmented reality marker (AR marker or fiduciary marker), whose position, scale and orientation are estimated with respect to a reference model of the marker (i.e. the race track geometry model) using known techniques. Hence the position of pixels within the high resolution image can be mapped to the reference geometry, for example using one or more affine transforms, based upon the estimated differences in position, scale and orientation with respect to the model.

Optionally, if the camera is locked off, then calibration objects may be used in the real environment in advance of the sporting event in order to facilitate this matching process.

Once mapped, the live video feed from the high resolution camera can be treated as a projection to be applied onto the geometric model of the race track. Given the geometry and the current video frame, a virtual camera viewpoint may then be generated by appropriately rendering the geometric model with that video frame projection applied.

In this way, the panning and zooming of the high resolution image is not limited to a planar panning within the image. Instead, different viewpoints may be selected by the virtual camera. Hence for example in FIG. 3A, the virtual camera is choreographed to follow a pre-set path through positions 11B, 12B, 13B, 14B, 15B and 16B, to give the impression of a camera on a boom being placed above the race track facing down the road, then pulling back to rotationally pan around the corner before moving back to look down the road exiting the bend. It will be appreciated that the virtual motion of the camera can be limited to select view points for which geometry is available, and/or to bound the geometry in a box or sphere so that pixels falling outside the available model are projected onto a distant surface.

Notably, because the real high resolution camera is locked off and the virtual camera is software controlled, such changes of viewpoint can be exactly repeated many times. Notably, the ability to consistently repeat a change in viewpoint also applies to the case of rotating the virtual camera about a fixed position.

Hence in an embodiment of the present disclosure, as an example a first race participant passes a timing unit 20D or ‘checkpoint’ near the entrance to the bend covered by the high definition video camera 10B. In response to this location trigger (i.e. in response to the participant's car passing the checkpoint), the video feed from the high definition camera is used to generate the choreographed coverage of the car passing the bend by the virtual camera. The choreography may include virtual motion of the camera as shown in FIG. 3A, or it may be a combination of pan, tilt and zoom of a virtual camera at the position of the real camera 10B as described previously.

In any event, this coverage may be used by the director in a live feed, but is also stored on the video server with universal time stamping as described previously.

When the first race participant passes the timing unit 20D again on the next lap, again the virtual camera can be used to execute exactly the same choreographed coverage.

Notably however, in addition the video stream for the virtual camera at the time the participant previously passed the checkpoint can also be requested (using the techniques described above). Now, exactly matching coverage of the first participant can also be shown, either side by side or, because the track and background will perfectly synchronise in both sets of coverage, as overlaid images.

For example, the first participant's car may be identified in the earlier video stream, and transposed to the current video stream with a semi-transparent alpha-value, to create a so-called ghost-car for easy comparison with the current driving position. Because the virtual viewpoints exactly match between video streams, the ghost car always appears at the correct position when transposed to the more recent video.

This enables a time-independent like-for-like comparison of the driver's performance for a track-side camera. It will be appreciated that this complements the multiple-view comparisons possible using the camera on the driver's car, as discussed previously.

For the purposes of extracting the first participant's car from the earlier video stream, the identification of the pixels corresponding to the car may use one or more of colour regions (distinguishing the car from the background tarmac), motion (identifying the changing edge positions of regions in the otherwise locked-off image), 3D models of the vehicle (to predict from the angle of view where pixels of the car should be), and/or the location data for the car at the relevant video frame, which can be similarly mapped to the geometric model (or may already use the geometric model) and hence predicts a relatively accurate region of the virtually generated video image in which the car should be found.

The alpha value (the apparent transparency) of the ghost car may change as appropriate. For example if the two images of the driver's car overlap, then the ghost car may become more transparent for the duration that this occurs. Similarly the cueing unit may monitor the contrast and brightness levels in the area of the ghost car and for example adapt the transparency depending on whether the track appears bright or dark at that point.

Alternatively or in addition to alpha values, other visual effects may be applied. For example, residual images of a car may be retained a fixed-viewpoint image to show a trace (if continuous) or a strobe-like series of snapshots, if discrete. The alpha values for these images may be a function of time from the current image so that they successively fade. For a virtual, moving viewpoint, then such additional residual images may be re-computed per frame if desired.

Hence in summary the above provides a position-aligned coverage of event participants with virtual camera choreography.

As noted above, it will be appreciated that this principle also applies to the virtual rotation and zoom of a virtual camera at the same position as the real high resolution camera 10B to provide a position-aligned coverage of event participants for a fixed position.

By contrast, in another embodiment of the present disclosure, a time-aligned coverage of event participants (as opposed to position-aligned) is provided with a fixed camera viewpoint (whether real and subsampled or virtual).

In this embodiment, as an illustrative example, the first race participant has their time t₀ at the start/finish line recorded with respect to the universal clock, and subsequently passes the timing unit 20D near the entrance to the bend at a universal time t₁. As the car passes the bend, the video feed from the high definition camera is used to generate a static viewpoint of the car passing.

This coverage may be used by the director in a live feed, but is also stored on the video server with universal time stamping as described previously.

The first race participant then has their time t₂ recorded again at the reference position of the start/finish line as they start a new lap. On this subsequent lap of the race track, the first race participant again passes the checkpoint 20D, this time at universal time t₃. Again as the car passes the bend, the video feed from the high definition camera is used to generate a matching static viewpoint of the car passing.

However, in addition, the video stream for the camera at a time t₀+(t₃−t₂) is cued by requesting the relevant frame for the resulting universal time. This second video stream is the video for the corresponding elapsed time in the previous lap.

Thus again the earlier car image can be extracted and used as a ghost car, this time providing a time-dependent visual comparison of the difference in position of the driver on the two laps.

However, in this case the video images are static, because the location triggered choreographed panning of the cars would almost certainly occur at different times (as the car will approach the bend at different times on different laps), and consequently a time-dependent comparison of the footage would not share the same viewpoint at the same time, making the creation of a ghost car impractical.

One option is to perform the choreographed coverage of the bend at a fixed time, or repeatedly at fixed intervals, so that two choreographed shots for the same elapsed time can be used. However, this cannot be relied upon to capture both cars (or both instances of the same car), if the time difference between them is large enough that they would not be in frame together during the choreographed moves of the virtual camera.

Consequently, in an embodiment of the present disclosure, the high resolution video images from the video camera are stored in the video server. When it is desired to compare a current instance of a car rounding the bend with an earlier instance, the high resolution video images for both instances are accessed, together with the position information for both cars (or both instances of the same car). The virtual camera choreography may then be adapted to select modified paths, viewpoints and/or fields of view that capture both cars in their respective video streams at the same time.

Hence in a first instance, with respect to the virtual pan, tilt and zoom of a camera at a fixed position corresponding to the real camera, the pan, tilt and zoom may be selected where possible to capture both cars in their respective video streams at the same time.

With regard to a virtual camera having motion with respect to the position of the real camera, then referring now also to FIG. 3B, in an adaptation of the choreography described previously the virtual camera follows the pre-set path through positions 11B, 12B, 13B, 14B, but alters the direction of view and field of view to accommodate one instance of the car reaching the corner first. The choreography is then modified to pull position 15B back further than before in order to accommodate a wide shot encompassing both cars at the bend, before following the trailing instance of the car out of the curve at the final position 16B.

It will be appreciated that with access to the location information for both cars (or both instances of a car) it is possible to pre-compute the alterations to the choreography (or simply to compute a new choreography) that places both cars on screen for as much of the time as possible.

For comparison with a live feed of a driver rounding the bend, the choreography can use either live location estimates for the current car, and/or image detection methods to identify the position of the car in the high definition video image, and then alter the position, direction and field of view to accommodate the ghost car in a similar manner to when both sets of location data are known, although in this case the choreography may have to adapt on a frame-by-frame basis.

Hence by storing the high definition video stream, it is possible to recompose choreographed coverage by a virtual camera to accommodate a ghost car arriving at the coverage point at a different time to a reference car (e.g. either a live car or a more recent recording of a car).

It will be appreciated that whilst the above examples have used successive laps and the same driver, they can of course apply to different drivers on the same lap, or different drivers on different laps (for example, comparing each driver to the video from the best lap time).

Similarly whilst the choreography has been described as pre-defined, it may be that the first pan, tilt, zoom and/or positional movement of the virtual camera is performed by the director and captured for subsequent re-use.

Similarly, the director may over-ride the choreographed coverage sequence with a new sequence (either pre-set from a library, or newly captured). In this case, prior coverage can be recomposed according the new sequence in the manner described above if the high resolution video image is stored on the video server, and/or the new sequence can be automatically modified as described above to accommodate the presence of multiple car images.

Hence more generally the virtual camera may take a calculated path; i.e. one either pre-set as a parametric curve or a series of waypoints, with field of view settings, direction settings and/or and relative timings, or as a recording of a directors' control of the virtual camera, possibly smoothed, or one of these with additional corrections to accommodate the positions of two or possibly more overlaid cars as respective videos of them are each projected onto the race track geometry.

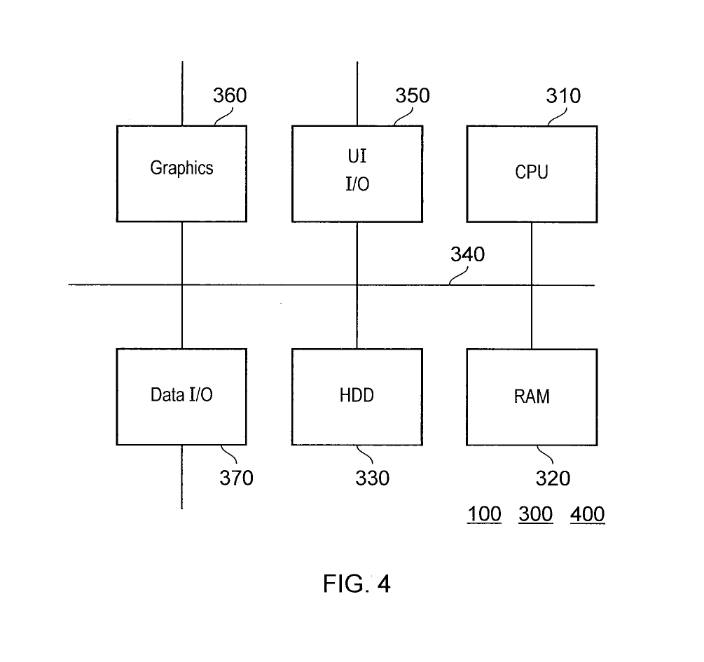

Referring now to FIG. 4, in an embodiment of the present disclosure the pre-processor, the cueing unit and the video comparator are each a general-purpose computer operating under suitable software instruction, or if the pre-processor and cueing unit are integrated, or the pre-processor and video comparator are integrated, or the cueing unit and video comparator are integrated, or all three units are integrated, may be a common general-purpose computer operating under suitable software instruction, to implement a method of video cueing. In each case, the general purpose computer 100, 300, 400 comprises a CPU 310, memory such as RAM 320 and a hard disk 330, operably connected via a common bus 340. The CPU is thus able to operate under software instruction from software from the HDD and/or RAM. In addition, a UI I/O 350 is operable to receive user inputs from, for example, a mouse, keyboard or touch screen. In conjunction with a graphics generator 360 operable to generate an image for display by a screen (not shown), this provides the user interface by which the director can view and select cued video streams or control the virtual camera. The data I/O 370 is operable to pass requests to a video server, or receive video image data, or frame position data from the video server, or receive participant location data from the pre-processor (if separate), or receive the universal clock signal.

In a summary embodiment of the present disclosure, it will thus be appreciated that using the fixed viewpoint high resolution camera, it is possible firstly to perform position-aligned coverage of event participants with virtual camera choreography; secondly to perform time-aligned coverage of event participants with a fixed camera viewpoint (whether real and subsampled or virtual); and/or thirdly to perform time-aligned coverage of event participants with adaptive virtual camera choreography if the high definition video used to generate the virtual camera viewpoint is stored by the video server.

Hence in the summary embodiment, a video comparison apparatus (400) for sports coverage comprises a video input (such as data I/O 370, for example coupled to the video server) arranged in operation to receive video frames of captured video footage from a video camera (10B) having a fixed viewpoint of a scene, the video frames being associated with respective times referenced to a universal clock (110). In addition, the video comparison apparatus comprises a control input (again such as data I/O 370, coupled for example to the pre-processor) is arranged in operation to receive event data indicating that an event has occurred, the event being associated with a time referenced to the universal clock. The video comparison apparatus also comprises a video processor (for example CPU 310), and a video compositor (for example CPU 310 and Graphics unit 360 operating together). In use, the video processor is then operable to select two or more instances of video footage associated with universal times responsive to the universal times of two or more instances of the event, and the video compositor is operable to superpose onto successive video frames of one instance of selected video footage at least a first part of a corresponding video frame from each of the one or more other selected instances of video footage.

Hence for example if the event is local to the camera (such as reaching a timing unit 20D), then video footage having the same universal time can be selected to generate position-dependent comparisons of the same event. Meanwhile if the event is a reference event, such as crossing the start/finish line to begin a new lap, then the video footage can have a common offset (for example equal to the time taken by one participant to reach the bend, or to reach timing unit 20D), in order to generate time-dependent comparisons of the same event.

However, as noted previously, to provide an alternative to a fixed-view or in-plane panning of the video for these comparisons, a virtual camera may be provided.

Hence in an instance of the summary embodiment, a video comparison apparatus in which the received video frames are of a resolution larger than an output resolution of the video compositor, the video comparison apparatus comprises a comparator (e.g. CPU 100) operable to project pixels of a video frame of the scene onto a virtual image plane that is orthogonal to the optical axis of a virtual camera positioned at the same position as the video camera and having a different optical axis to the video camera, to form a virtual camera viewpoint of the video frame, as described previously with respect to FIG. 6.

In an instance of the summary embodiment, the starting frame of each selected instance of video footage is associated with a respective universal time substantially the same as the respective time of the respective instances of the event, such that the start of each instance of the footage is synchronised to the respective instance of the event, and the comparator is arranged in operation to form respective video sequences using the selected instances of video footage (i.e. new virtual projections for each frame in the original video sequence), for a same calculated path of the virtual camera, and to output the video sequences as selected instances of video footage for the compositor.

In an instance of the summary embodiment, the starting frame of each selected instance of video footage is associated with a respective universal time that is offset by the same amount with respect to the time of the respective instances of the event, such that the start of each instance of the footage has the same elapsed time since the respective instance of the event. Then, the video processor is operable to access location data for participants of the sport that is indicative of the location of the or each participant in the scene at the time of a respective video frame for each selected instance of video footage, and the comparator is operable to form respective video sequences using the selected instances of video footage, for a same calculated path of the virtual camera. The comparator is then arranged in operation to calculate a view for the virtual camera that for a respective video frame, positions the field of view of the virtual camera to simultaneously encompass the location of a participant in two or more selected instances of video footage.

Similarly for a movable virtual camera, in an instance of the summary embodiment, the received video frames are of a resolution larger than an output resolution of the video compositor (for example 3840×2160 pixels compared to HD). Meanwhile the video comparison apparatus comprises a memory (such as RAM 320 and/or HDD 330) storing a geometry model of some or all of the scene viewed by the fixed camera, a comparator (for example CPU 310) operable to compare the position of features within a video frame of the scene with corresponding features in the geometry model, and subsequently operable to derive a mapping from the video frame to the geometry model, and a renderer (for example CPU 310 and Graphics unit 360 operating together) operable to texture pixels of a video frame onto the geometry model in accordance with the derived mapping, and to render a virtual camera viewpoint of the textured geometry model.

For the position-dependent comparisons, then as described previously, in an instance of the summary embodiment the starting frame of each selected instance of video footage is associated with a respective universal time substantially the same as the respective time of the respective instances of the event, such that the start of each instance of the footage is synchronised to the respective instance of the event. Then, the renderer can render respective video sequences using the selected instances of video footage, for a same calculated path of the virtual camera with respect to the geometry model, and to output the renders as selected instances of video footage for the compositor.

In this way video footage cued to respective instances of the same starting position (e.g. at timing unit 20D) is then rendered by the virtual camera in an identical fashion, enabling a spatially consistent compositing of the resulting videos.

By contrast for the time-dependent comparisons, then as described previously, in an instance of the summary embodiment the starting frame of each selected instance of video footage is associated with a respective universal time that is offset by the same amount with respect to the time of the respective instances of the event, such that the start of each instance of the footage has the same elapsed time since the respective instance of the event. Hence for example the event may be when a participant passes the start/finish line to begin a new lap. In this case therefore each instance of the selected video footage starts at the same time with respect to the start of a lap.

Meanwhile the video processor is operable to access location data for participants of the sport (for example using the data I/O 370, coupled to the pre-processor) that is indicative of the location of the or each participant in the scene at the time of a respective video frame for each selected instance of video footage, as described previously. The renderer is then operable to render respective video sequences using the selected instances of video footage, for a same calculated path of the virtual camera with respect to the geometry model, in which the renderer calculates a path for the virtual camera that for a respective video frame, positions the field of view of the virtual camera to simultaneously encompass the location of a participant in two or more selected instances of video footage.

In other words, as described previously the renderer selects a viewpoint for the virtual camera, and hence selects one or more of a position, direction and width of view, that will encompass the position of two or more cars when those cars are subsequently composited to onto the same image.

Where there are occasions where it is not possible to encompass all the cars in the selected instances, the renderer may calculated a path that keeps participants in view in an order of preference that may be automatically determined; for example, the order of preference may be reverse-chronological for comparing different laps, so that the most recent laps are preferentially kept in the composite shot. Similarly the order of preference may be the race order, so that the leading participants are preferentially kept in the composite shot.

As noted previously, the path may be calculated as a series of modifications to a predefined path, either defined parametrically or by capturing a director's control of the virtual camera.

In an instance of the summary embodiment, the video compositor is operable to superpose onto a video frame of one instance of selected video footage at least a first part of a corresponding video frame from another selected instance of video footage in which the first part of the corresponding video frame comprises an image of a participant of the sporting event. Hence, as explained previously, the compositor can extract the image of the participant (e.g. the image of the racing car) from the or each other video frame for inclusion with the selected video frame.

Consequently, the video compositor is operable to superpose the first part of the corresponding video frame on the video frame of one instance of selected video footage with a transparency responsive to the respective distance between the image of the participant of the sporting event in the first part of the corresponding video frame, and a participant of the sporting event in the video frame upon which the first part of the corresponding video frame is being superposed.

Consequently, as described previously, the ghost car can fade more as it approaches the ‘solid’ car in the current view, so that this car is not so confusingly mixed with the ghost car.

The video comparison apparatus 400 as described herein will typically be installed as part of a broader video system comprising the video server 200, and optionally the pre-processor 100, the cueing unit 300 and RF transceiver equipment operable to receive and extract wireless telemetry data and/or video data (not shown).

The video comparison apparatus, or the video system as described above, will typically also be installed as part of the infrastructure of a racing track, and thus in an instance of the summary embodiment forms a sports coverage system comprising the video comparison apparatus, the video server, and one or more fixed viewpoint high definition cameras.

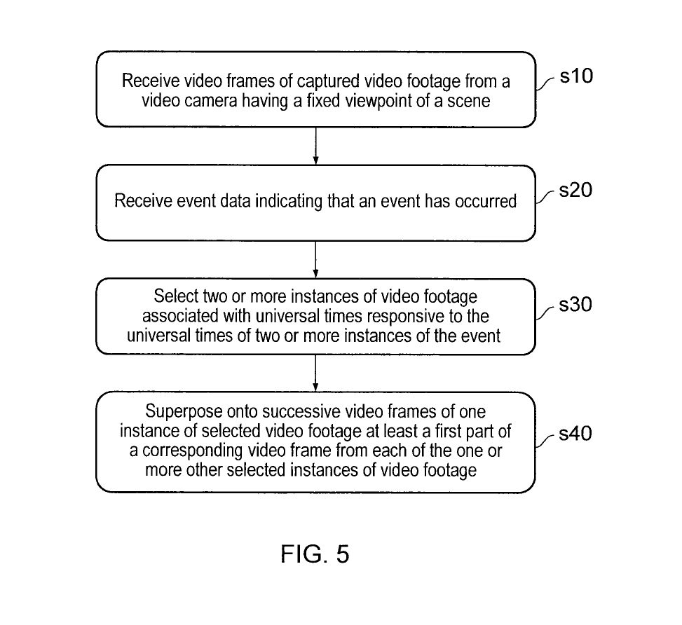

Turning now to FIG. 5, a method of video comparison comprises:

In a first step s10, receiving video frames of captured video footage from a video camera having a fixed viewpoint of a scene (with the video frames associated with respective times referenced to the universal clock);

In a second step s20, receiving event data indicating that an event has occurred (with the event similarly being associated with a time referenced to the universal clock);

In a third step s30, selecting two or more instances of video footage associated with universal times responsive to the universal times of two or more instances of the event; and

In a fourth step s40, superposing onto successive video frames of one instance of selected video footage at least a first part of a corresponding video frame from each of the one or more other selected instances of video footage.

It will be apparent to a person skilled in the art that variations in the above method corresponding to operation of the various embodiments of the apparatus as described and claimed herein are considered within the scope of the present disclosure, including but not limited to:
where the received video frames are of a resolution larger than an output resolution of the video compositor, projecting pixels of a video frame of the scene onto a virtual image plane that is orthogonal to the optical axis of a virtual camera positioned at the same position as the video camera and having a different optical axis to the video camera, to form a virtual camera viewpoint of the video frame,
   Consequently, where the starting frame of each selected instance of video footage is associated with a respective universal time substantially the same as the respective time of the respective instances of the event, such that the start of each instance of the footage is synchronised to the respective instance of the event, then forming respective video sequences using the selected instances of video footage, for a same calculated path of the virtual camera, and outputting the video sequences as selected instances of video footage for superposition, or
   Where the starting frame of each selected instance of video footage is associated with a respective universal time that is offset by the same amount with respect to the time of the respective instances of the event, such that the start of each instance of the footage has the same elapsed time since the respective instance of the event, accessing location data for participants of the sport that is indicative of the location of the or each participant in the scene at the time of a respective video frame for each selected instance of video footage, forming respective video sequences using the selected instances of video footage, for a same calculated path of the virtual camera, and then calculating a path for the virtual camera that, for a respective video frame, positions the field of view of the virtual camera to simultaneously encompass the location of a participant in two or more selected instances of video footage.
Similarly for the case where the virtual camera can move from the position of the real camera, then where the received video frames are of a resolution larger than an output resolution of the video compositor, storing a geometry model of some or all of the scene viewed by the fixed camera, comparing the position of features within a video frame of the scene with corresponding features in the geometry model, deriving a mapping from the video frame to the geometry model, texturing pixels of a video frame onto the geometry model in accordance with the derived mapping, and rendering a virtual camera viewpoint of the textured geometry model;
   Consequently, where the starting frame of each selected instance of video footage is associated with a respective universal time substantially the same as the respective time of the respective instances of the event, such that the start of each instance of the footage is synchronised to the respective instance of the event, then rendering respective video sequences using the selected instances of video footage, for a same calculated path of the virtual camera with respect to the geometry model, and outputting the renders as selected instances of video footage for superposition, or
   where the starting frame of each selected instance of video footage is associated with a respective universal time that is offset by the same amount with respect to the time of the respective instances of the event, such that the start of each instance of the footage has the same elapsed time since the respective instance of the event, then accessing location data for participants of the sport that is indicative of the location of the or each participant in the scene at the time of a respective video frame for each selected instance of video footage, and rendering respective video sequences using the selected instances of video footage, for a same calculated path of the virtual camera with respect to the geometry model, in which the step of rendering comprises calculating a path for the virtual camera that, for a respective video frame, positions the field of view of the virtual camera to simultaneously encompass the location of a participant in two or more selected instances of video footage;
      here, the path may be calculated as a series of modifications to a predefined path.
Superposing onto a video frame of one instance of selected video footage at least a first part of a corresponding video frame from another selected instance of video footage, in which the first part of the corresponding video frame comprises an image of a participant of the sporting event; and
   Consequently, superposing the first part of the corresponding video frame on the video frame of one instance of selected video footage with a transparency responsive to the respective distance between the image of the participant of the sporting event in the first part of the corresponding video frame, and a participant of the sporting event in the video frame upon which the first part of the corresponding video frame is being superposed.

Finally, it will be appreciated that the methods disclosed herein may be carried out on conventional hardware suitably adapted as applicable by software instruction or by the inclusion or substitution of dedicated hardware.

Thus the required adaptation to existing parts of a conventional equivalent device may be implemented in the form of a non-transitory computer program product or similar object of manufacture comprising processor implementable instructions stored on a data carrier such as a floppy disk, optical disk, hard disk, PROM, RAM, flash memory or any combination of these or other storage media, or in the form of a transmission via data signals on a network such as an Ethernet, a wireless network, the Internet, or any combination of these of other networks, or realised in hardware as an ASIC (application specific integrated circuit) or an FPGA (field programmable gate array) or other configurable circuit suitable to use in adapting the conventional equivalent device.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

### CROSS REFERENCE TO RELATED APPLICATIONS

The present application claims priority to United Kingdom Application GB1208401.8 filed on 14 May 2012, the contents of which being incorporated herein by reference in its entirety.

1. A video comparison apparatus for sports coverage, comprising:
a video input arranged in operation to receive video frames of captured video footage from a video camera having a fixed viewpoint of a scene, the video frames being associated with respective times referenced to a universal clock;
a control input circuitry is arranged in operation to receive event data indicating that an event has occurred, the event being associated with a time referenced to the universal clock;
a video processor; and
a video compositor,
and in which
the video processor circuitry is configurable to select two or more instances of video footage associated with universal times responsive to the universal times of two or more instances of the event; and
the video compositor circuitry is configurable to superpose onto successive video frames of one instance of selected video footage at least a first part of a corresponding video frame from each of the one or more other selected instances of video footage.

2. The video comparison apparatus according to claim 1 in which the received video frames are of a resolution larger than an output resolution of the video compositor, the video comparison apparatus comprising:
a comparator circuitry configured to project pixels of a video frame of the scene onto a virtual image plane that is orthogonal to the optical axis of a virtual camera positioned at the same position as the video camera and having a different optical axis to the video camera, to form a virtual camera viewpoint of the video frame.

3. The video comparison apparatus according to claim 2, in which:
the starting frame of each selected instance of video footage is associated with a respective universal time substantially the same as the respective time of the respective instances of the event, such that the start of each instance of the footage is synchronised to the respective instance of the event; and
the comparator circuitry is arranged in operation to form respective video sequences using the selected instances of video footage, for a same calculated path of the virtual camera, and to output the video sequences as selected instances of video footage for the compositor.

4. The video comparison apparatus according to claim 2, in which:
the starting frame of each selected instance of video footage is associated with a respective universal time that is offset by the same amount with respect to the time of the respective instances of the event, such that the start of each instance of the footage has the same elapsed time since the respective instance of the event;
the video processor circuitry is configured to access location data for participants of the sport that is indicative of the location of the or each participant in the scene at the time of a respective video frame for each selected instance of video footage; and
the comparator circuitry is configured to form respective video sequences using the selected instances of video footage, for a same calculated path of the virtual camera, and in which
the comparator circuitry configured is arranged in operation to calculate a view for the virtual camera that for a respective video frame, positions the field of view of the virtual camera to simultaneously encompass the location of a participant in two or more selected instances of video footage.

5. The video comparison apparatus according to claim 1 in which the received video frames are of a resolution larger than an output resolution of the video compositor, the video comparison apparatus comprising:
a memory configured to store a geometry model of some or all of the scene viewed by the fixed camera;
a comparator circuitry configured to compare the position of features within a video frame of the scene with corresponding features in the geometry model, and subsequently operable to derive a mapping from the video frame to the geometry model; and
a renderer circuitry configured to project pixels of a video frame onto the geometry model in accordance with the derived mapping, and to render a virtual camera viewpoint of the projected pixels on geometry model.

6. The video comparison apparatus according to claim 5, in which:
the starting frame of each selected instance of video footage is associated with a respective universal time substantially the same as the respective time of the respective instances of the event, such that the start of each instance of the footage is synchronised to the respective instance of the event; and
the renderer circuitry configured in operation to render respective video sequences using the selected instances of video footage, for a same calculated path of the virtual camera with respect to the geometry model, and to output the renders as selected instances of video footage for the compositor.

7. The video comparison apparatus according to claim 5, in which:
the starting frame of each selected instance of video footage is associated with a respective universal time that is offset by the same amount with respect to the time of the respective instances of the event, such that the start of each instance of the footage has the same elapsed time since the respective instance of the event;
the video processor circuitry configured to access location data for participants of the sport that is indicative of the location of the or each participant in the scene at the time of a respective video frame for each selected instance of video footage; and
the renderer circuitry configured to render respective video sequences using the selected instances of video footage, for a same calculated path of the virtual camera with respect to the geometry model, and in which
the renderer circuitry configured in operation to calculate a path for the virtual camera that for a respective video frame, positions the field of view of the virtual camera to simultaneously encompass the location of a participant in two or more selected instances of video footage.

8. The video comparison apparatus according to claim 7, in which the path is calculated as a series of modifications to a predefined path.

9. The video comparison apparatus according to claim 1, in which
the video compositor circuitry configured to superpose onto a video frame of one instance of selected video footage at least a first part of a corresponding video frame from another selected instance of video footage, and in which
the first part of the corresponding video frame comprises an image of a participant of the sporting event.

10. The video comparison apparatus according to claim 9, in which the first part of the corresponding video frame is superposed on the video frame of one instance of selected video footage with a transparency responsive to the respective distance between the image of the participant of the sporting event in the first part of the corresponding video frame, and a participant of the sporting event in the video frame upon which the first part of the corresponding video frame is being superposed.

11. A video system, comprising:
the video comparison apparatus according to claim 1; and
a video server.

12. A sports coverage system, comprising
the video comparison apparatus according to claim 1;
a video server; and
one or more fixed viewpoint high definition cameras.

13. A method of video comparison for sports coverage, comprising the steps of:
receiving video frames of captured video footage from a video camera having a fixed viewpoint of a scene, the video frames being associated with respective times referenced to a universal clock;
receiving event data indicating that an event has occurred, the event being associated with a time referenced to the universal clock;
selecting two or more instances of video footage associated with universal times responsive to the universal times of two or more instances of the event; and
superposing onto successive video frames of one instance of selected video footage at least a first part of a corresponding video frame from each of the one or more other selected instances of video footage.

14. The method according to claim 13 in which the received video frames are of a resolution larger than an output resolution of the video compositor, the method comprising the steps of:
projecting pixels of a video frame of the scene onto a virtual image plane that is orthogonal to the optical axis of a virtual camera positioned at the same position as the video camera and having a different optical axis to the video camera, to form a virtual camera viewpoint of the video frame.

15. The method according to claim 14 in which the starting frame of each selected instance of video footage is associated with a respective universal time substantially the same as the respective time of the respective instances of the event, such that the start of each instance of the footage is synchronised to the respective instance of the event,
the method comprising the steps of:
forming respective video sequences using the selected instances of video footage, for a same calculated path of the virtual camera; and
outputting the video sequences as selected instances of video footage for superposition.

16. The method according to claim 14 in which the starting frame of each selected instance of video footage is associated with a respective universal time that is offset by the same amount with respect to the time of the respective instances of the event, such that the start of each instance of the footage has the same elapsed time since the respective instance of the event,
the method comprising the steps of:
accessing location data for participants of the sport that is indicative of the location of the or each participant in the scene at the time of a respective video frame for each selected instance of video footage; and
forming respective video sequences using the selected instances of video footage, for a same calculated path of the virtual camera,
and in which
the step of forming the video comprises calculating a path for the virtual camera that, for a respective video frame, positions the field of view of the virtual camera to simultaneously encompass the location of a participant in two or more selected instances of video footage.

17. The method according to claim 13 in which the received video frames are of a resolution larger than an output resolution of the video compositor, the method comprising the steps of:
storing a geometry model of some or all of the scene viewed by the fixed camera;
comparing the position of features within a video frame of the scene with corresponding features in the geometry model;
deriving a mapping from the video frame to the geometry model;
texturing pixels of a video frame onto the geometry model in accordance with the derived mapping; and
rendering a virtual camera viewpoint of the textured geometry model.

18. The method according to claim 17 in which the starting frame of each selected instance of video footage is associated with a respective universal time substantially the same as the respective time of the respective instances of the event, such that the start of each instance of the footage is synchronised to the respective instance of the event,
the method comprising the steps of:
rendering respective video sequences using the selected instances of video footage, for a same calculated path of the virtual camera with respect to the geometry model; and
outputting the renders as selected instances of video footage for superposition.

19. The method according to claim 17 in which the starting frame of each selected instance of video footage is associated with a respective universal time that is offset by the same amount with respect to the time of the respective instances of the event, such that the start of each instance of the footage has the same elapsed time since the respective instance of the event,
the method comprising the steps of:
accessing location data for participants of the sport that is indicative of the location of the or each participant in the scene at the time of a respective video frame for each selected instance of video footage; and
rendering respective video sequences using the selected instances of video footage, for a same calculated path of the virtual camera with respect to the geometry model,
and in which
the step of rendering comprises calculating a path for the virtual camera that, for a respective video frame, positions the field of view of the virtual camera to simultaneously encompass the location of a participant in two or more selected instances of video footage.

20. The method according to claim 19 in which the path is calculated as a series of modifications to a predefined path.

21. The method according to claim 13, in which the step of superposing comprises:
superposing onto a video frame of one instance of selected video footage at least a first part of a corresponding video frame from another selected instance of video footage,
and in which
the first part of the corresponding video frame comprises an image of a participant of the sporting event.

22. The method according to claim 21, in which the first part of the corresponding video frame is superposed on the video frame of one instance of selected video footage with a transparency responsive to the respective distance between the image of the participant of the sporting event in the first part of the corresponding video frame, and a participant of the sporting event in the video frame upon which the first part of the corresponding video frame is being superposed.

23. A non-transitory computer readable medium including computer program instructions, which when executed by a computer causes the computer to perform the method of claim 13.
